(19) United States
(12) Patent Application Publication
(10) Pub. No.: US 2026/0245104 A1
(43) Pub. Date: Aug. 20, 2026

(54) VALIDATE PREQUALIFICATION AND LEAD SUBMISSION FLOWS USING A SYNTHETIC USER

(71) Applicant: Capital One Services, LLC, McLean, VA (US)

(72) Inventors: David GILLAM, The Colony, TX (US); Evan ARMBRISTER, Hollywood, FL (US); Shahryar RASHID, Plano, TX (US); Harish KATHPALIA, Plano, TX (US); Vijayalakshmi Narasimha Raju KALIDINDI, Frisco, TX (US); Ameer MUBAREZ, Frisco, TX (US)

(73) Assignee: Capital One Services, LLC, McLean, VA (US)

(21) Appl. No.: 19/054,021

(22) Filed: Feb. 14, 2025

(51) Int. Cl. G06Q 30/0201; G06F 21/64

(52) U.S. Cl. CPC G06Q 30/0201; G06F 21/64

(57) ABSTRACT

Aspects disclosed provide system and method validating data integrity. Whether a data object represents a synthetic user may be determined based on a value of a most significant bit in a predetermined field of a universally unique identifier (UUID) associated with the data object. The data object may comprise encoded attributes of the synthetic user which may be used to validate accuracy of data transformations performed by a sub-system on the encoded attributes. Validating the accuracy of the data transformations and routing of the data object may be done in real-time and during a production session of the sub-system. Results of the data transformations may be received and compared with expected results based on a pairwise comparison of the results with the expected results in the patterns of attributes of the data object indicative of how the data object is to be tested may be detected at a desired destination.

### CROSS-REFERENCE TO RELATED APPLICATIONS

This application relates to U.S. Application. No. __/______, which is co-filed on Feb. 14, 2025, entitled “Data Accuracy Automation Framework.” The content of the application is incorporated herein in its entirety.

### TECHNICAL FIELD

Aspects relate to the field of system testing, particularly testing of integrated systems and their sub-components.

### BACKGROUND

Integrated computer implemented systems are often complex and require input data to be transformed many times over while propagating throughout the system. For example, integrated systems related to e-commerce, banking, or multimedia applications can receive input data that must be manipulated and transformed to generate an output. The output may be the completion of a transaction, the conversion of data to another form, or the display of a particular output, etc. However, any errors made in manipulating and/or transforming the data at a particular stage will propagate throughout the system and result in faulty outputs. Thus, testing if the system is working at every stage, e.g., manipulating data, properly, is essential to ensuring that these systems work properly. Identifying errors early on and isolating the source of errors is desirable. Thus, an improved automated framework to test data integrity of these systems is necessary.

### SUMMARY

Aspects disclosed herein provide a system and methods for validating data integrity and routing, and performing custom tests on synthetic data objects of an integrated system. The system is unique in that it provides for validating data integrity and routing and performing custom tests on synthetic data objects during a live/production session, and in real-time, while the integrated system is processing live/production data, rather than performing any validation in a test environment. In this way, the system can determine which of the sub-components may be faulty in real-time, and for a system that is in use. Throughout this disclosure, the example integrated system discussed will primarily be with respect to banking applications, particularly those for generating preferred pricing and/or financing terms for consumers when shopping for preferred terms and/or pricing for financing a purchase. However, this is merely exemplary and the techniques described herein can be applied to any integrated system, in which data is propagated and transformed at various stages, resulting in an output that is transformed based on the input data. The techniques used can be applied in a variety of applications. For example, applications can be in processing healthcare data, banking, e-commerce systems, multimedia systems, etc.

In order to perform its functions and perform testing in a live/production environment, the system generates test data to propagate through the environment. In aspects, this test data can include synthetic data. Synthetic data refers to test data designed to mimic real-world production input data that would be provided into the system. However, the synthetic data is unique because it is formatted, patterned, and structured in a customized and unique way, allowing the integrated system to determine that it is test data and that it is to be treated and routed in a particular manner. Thus, the synthetic data comprises indicators for how that data is to be identified, treated, routed, and tested by the system. The formatting, patterns, and structure of the synthetic data is associated with what particular testing scenarios are run on the data. How this is done will be described in detail below.

In aspects, the system can perform the aforementioned functionality by first receiving a data object representing a request of a synthetic user. The synthetic user refers to fictitious data. The fictitious data can represent a variety of input data. In the context of a banking system, this fictitious data can represent, for example, data input by a user when shopping for pre-qualifications, preferred pricing, a loan, or financing when the user wants to purchase a good or service. The synthetic user is used in place of an actual user so that the system can be tested using test data rather than be tested on real-world user data. For example, if the integrated system is designed to generate loan offers based on user personal and financial information, the synthetic user may be a fictitious user with fictitious personal and financial information that can mimic a real-world user's information that is typically used in a loan application. In aspects, the synthetic user's personal and financial information (herein after referred to as “attributes”) can be encoded. This encoding provides several benefits, as will be described below, but most notably this encoding enables the synthetic user's attributes to be routed and processed throughout the system so that various functions of the system can be tested. The encoding, encodes patterns in the attributes that can be recognized by the system to route the synthetic user's information to different sub-components of the system based on the pattern recognized.

In aspects, the data object can include the encoded attributes of the synthetic user. In aspects, and as indicated, the encoded attributes can be used to validate accuracy of data transformations performed by a sub-system of the integrated system on the encoded attributes. In aspects, validating the accuracy of the data transformations is done in real-time and during a production session of the sub-system.

In aspects, based on receiving the data object, the data object can be transmitted to the sub-system so that the sub-system can perform its data transformations on the attributes. In aspects, results of the data transformations can be received/obtained. In aspects, in order to validate the results, a comparison is done between the results of the transformations performed, and expected results. The expected results are based on pre-defined “scenarios” built into the system and have known and expected outputs that should be generated based on the synthetic data that was originally received and propagated throughout the system. Thus, different synthetic data inputs can trigger various scenarios that indicate what the expected outcome of the system transformation would/should be as a result of processing the synthetic data. Any discrepancy between the results of the transformation performed and the scenarios would indicate an error in the system. In this way, different synthetic data can trigger different scenarios, and through the use of this different synthetic data and different scenarios, various functions and subsystems can be tested to see where any errors lie. For example, changes in the synthetic data that should result in varying loan terms can test a loan term generating module. If discrepancies between what is expected and what is output is determined, it can be determined that the loan term generating module is faulty. Similarly, if a synthetic data is input such that it would trigger a particular credit score calculation, and there is a discrepancy between the expected result and what is output by the system based on the synthetic data, it can be determined that the module that calculates the credit score is faulty. The aforementioned are merely examples and not meant to be limiting. A person of ordinary skill in the art (“POSA”) will recognize other aspects that can be tested based on the aforementioned.

In aspects, this comparison between the results of the transformation and the expected results can be done in a pairwise manner, by comparing the results and expected values that the sub-system was to output. In aspects, based on determining that all the results and the expected results match, the system can generate a success message that the data transformations were accurately performed. If, however, a discrepancy is found between the results and the expected values, it can be determined that an error is occurring somewhere within the transformations. The source of the error can easily be identified due to knowing the responsibilities of the sub-system that generated the faulty result based on the encoding and the particular discrepancy in a particular attribute field that doesn't conform to the expected results.

The aforementioned testing scenario is based on data propagating through the sub-system. This is referred to as a “southbound” testing scenario. In the context of the banking application previously mentioned, this can test, for example, whether data input into the system is processed properly such that it is received and a loan offer can be generated based off that information. However, in aspects, the system can also perform the reverse operation and validate data coming back to marketplaces, such that it can test whether the sub-system is transmitting the correct output/offer back to the synthetic user. This is referred to as a “northbound” testing scenario.

In aspects, the system can perform the “northbound” testing scenario by receiving a further data object representing an expected response to the request. In aspects, the further data object includes the expected results. In aspects, the expected results are used to validate accuracy of further data transformations performed by the sub-system on the expected results. For example, if outputs are generated as a result of processing the user data, those outputs need to be correctly transmitted back to the user. The sub-system, in transmitting that output may have to transform that data in a certain way so that the user can view and/or receive it in a form that the user can understand. Such transformations may be converting files to different formats, generating certain graphics and interfaces to present the output, converting the output to units that are understandable to the user, etc. The aforementioned are merely exemplary, and a POSA reading this disclosure will understand the type of transformations that can occur based on the function of the integrated system.

In aspects, validating the accuracy of the further data transformations, similar to what was described above, is done in real-time and during the live/production session of the sub-system. In aspects, the further data object can be transmitted to the sub-system to perform the further data transformations. In aspects, the further data transformation will lead to further results being received. The further results represent the expected outputs that the user should receive. In aspects, the further results can be compared with further expected results of what the sub-system was to output when performing the further data transformations. In aspects, the comparison can be done in a pairwise manner. In aspects, based on determining that all the further results and the further expected results match, the system can generate a further success message that the further data transformation were accurately performed. Again, if there is a discrepancy between the further results and the further expected results, it can be determined that there is an error, which can be pinpointed based what particular data is found to be erroneous and tying that data to the components of the sub-system responsible for generating that data.

In aspects, routing and performing custom tests on the synthetic data object can also be done in real-time and during the live/production session of the sub-system. Whether a data object represents a synthetic user is determined based on a unique identifier associated with the data object. The data object is routed through a production session of the sub-system to a desired destination based on determining that the data object represents the synthetic user. Patterns of attributes of the data object indicative of how the data object is to be tested at the desired destination is detected at the desired destination. Custom tests are performed on the data object based on detecting the patterns within the data object, and the custom tests performed are based on the patterns of the attributes.

In aspects, patterns of attributes may indicate whether the data object should be approved or rejected for the loan terms. The patterns of attributes can be varied by modifying values associated with the data object.

Certain aspects have other steps or elements in addition to or in place of those mentioned above. The steps or elements will become apparent to a POSA from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a POSA to make and use the aspects.

FIG. 1 is an example system for validating data integrity according to aspects.

FIG. 2 is an example method of validating data integrity according to aspects.

FIG. 3 is another example method of validating data integrity according to aspects.

FIG. 4 is an example architecture of the components that may be used to implement the computing devices of the system according to aspects.

### DETAILED DESCRIPTION

Provided herein are system, apparatus, device, method and/or computer program product aspects, and/or combinations and sub-combinations thereof, for validating data integrity. The system described herein may identify synthetic data, e.g., those representing non-human initiated transactions, among all data received based on a predetermined pattern and/or attributes of the synthetic data. The synthetic data may include a synthetic request that simulates an actual human initiated request. A sub-system may transform certain attributes of the synthetic request based on specific rules, e.g., depending on where the request needs to be transmitted. The system may validate the transformed data by comparing the transformed data with expected results. A synthetic response, corresponding to and/or responding to the synthetic request, may be transmitted by another module of the system. The sub-system may further transform attributes of the synthetic response based on rules, e.g., depending on where the synthetic response needs to be transmitted. The system may validate the further transformed attributes by comparing the further transformed response with further expected results. This way, whether the sub-system is working correctly may be examined.

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of the disclosure. However, it will be apparent that the disclosure may be practiced without these specific details. In order to avoid obscuring an aspect of the present disclosure, some well-known circuits, system configurations, architectures, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an aspect of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

### System Overview and Function

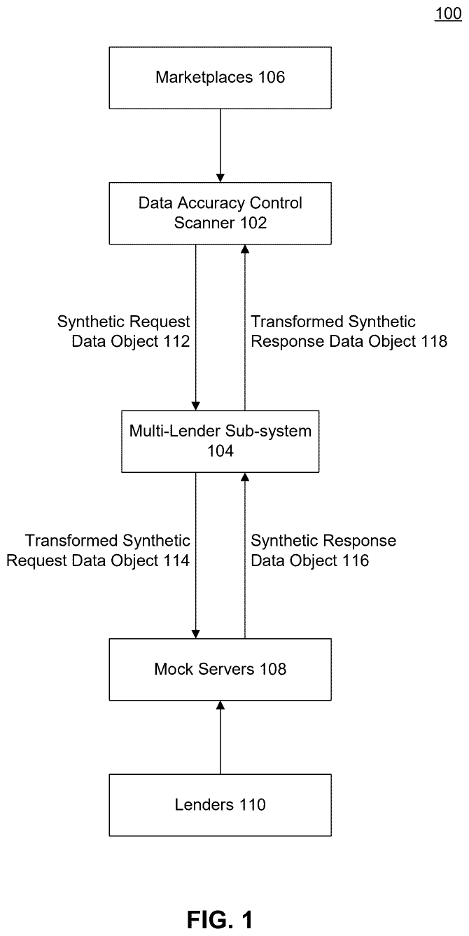

FIG. 1 is an example system 100 for validating data integrity according to aspects. In aspects, the system 100 may be implemented on one or more computing devices of backend computing infrastructure, including server infrastructure of a company, institution, government entity, etc.

In aspects, and as shown in FIG. 1, the computing devices of the backend computing infrastructure may have various software modules stored thereon to enable the functions of the system 100. In aspects, these modules can include a data accuracy control scanner (scanner) module 102, a multi-lender sub-system 104, and mock servers 108. Each of these components will be discussed in detail below. The marketplaces 106 may be a data repository for storing and/or a portal for receiving requests from actual clients. The lenders 110 may be a portal for lenders, e.g., through which, lenders can provide proprietary information used to prequalify applicants and determine user specific terms and pricing offers.

In aspects, the multi-lender sub-system 104 may be a part of a secure unified system 100 for users to apply for a purchase of a good or service from multiple providers using provider specific methodologies for generating offers for the good or service. In aspects, the offers may be offers for financing terms for the good. The secure unified system 100 may be used for securely storing proprietary information and generating a pre-qualification or a pricing term for a good. For example, the multi-lender sub-system 104 may include interactive micro-services that communicate together in a bi-directional manner to create a normalized process for generating terms custom to a user when purchasing a good, such as commercial goods/products (e.g. a vehicle) or real property. In aspects, the micro-services may assess pre-qualification for a loan or financing for a good, followed by determining eligibility of the good for financing, and further followed by calculating pricing details for loans (e.g. for financing purchase of the good) that would be offered for a consumer's particular financial credentials, for each of a plurality of lenders. Such a multi-lender sub-system 104 is described in U.S. application. Ser. No. 16/881,945, filed May 22, 2020, U.S. application. Ser. No. 16/881,897, filed May 22, 2022, and U.S. application. Ser. No. 18/419,670, filed Jan. 23, 2024. The content of these applications is incorporated herein in their entireties.

Throughout this disclosure the term “provider” and “lender” will be used interchangeably. The lender pre-qualification and pricing may be performed on a product/service by product/service and user by user basis. In aspects, to generate the pricing terms/loan offers, the multi-lender sub-system 104 may process requests from users and/or responses from lenders. For example, the multi-lender sub-system 104 may receive pre-qualification and/or pricing requests from users. The multi-lender sub-system 104 may receive pre-qualification and/or pricing responses from lenders based on the requests.

In aspects, a pre-qualification request may be a request for determining eligibility of a pricing term/loan offer for a user. In aspects, a pre-qualification response may be a response to a pre-qualification request, e.g., a decision on eligibility of loan, pricing term, offer, discount, etc. for the purchase of a good for financing. In aspects, a pricing request may be a request for calculating pricing details, e.g., annual percentage rate (APR) or payment, for the loan. In aspects, a pricing response may be a response to a pricing request, e.g., with pricing details for a loan.

In aspects, the multi-lender sub-system 104 may generate a loan or financing application upon receiving a pre-qualification or pricing request. In aspects, and in the context of the disclosure, some of these requests may be synthetic requests of synthetic users, generated to test whether the multi-lender sub-system 104 is processing the inputs and outputs correctly. In aspects, the multi-lender sub-system 104 may identify synthetic requests among all requests and differentiate them from those sent by actual clients based on various mechanisms such as a unique identifier and specific attribute value patterns, as will be described later.

In aspects, a data object (e.g., the synthetic request data object 112) may represent the synthetic request of a synthetic user. The synthetic request data object 112 may comprise encoded attributes of the synthetic user. The encoded attributes may be used to validate accuracy of data transformations performed by the multi-lender sub-system 104 on the encoded attributes. Validating the accuracy of the data transformations may be done in real-time and during a production session of the multi-lender sub-system 104. Validating the accuracy of the data transformations in real-time and during a production session, parallel to live production, may help identify issues associated with the live production environment in real-time without halting, stopping, pausing, interrupting, and/or disturbing the production process. Thus productivity improves while allowing for identification of errors and problems within the actual working environment of the multi-lender sub-system 104.

The scanner module 102 may send synthetic requests, for example the synthetic request data object 112, to (or receive synthetic responses, for example the transformed synthetic response data object 118, from) the multi-lender sub-system 104. The scanner module 102 interfaces with the marketplaces 106. The marketplaces 106 represents the universe of user provided data that is input into the multi-lender sub-system 104. In aspects, the synthetic request may be generated and/or transmitted to the multi-lender sub-system 104 periodically or responsive to predetermined events. For example, the synthetic request may be generated once a month, once a day, and/or responsive to an error being reported in live production.

The mock servers 108 may receive synthetic requests from (or send synthetic responses to) the multi-lender sub-system 104. The mock servers 108 may mimic actual lender behavior to validate request data and/or send responses back. For a synthetic request received from the multi-lender sub-system 104, the mock servers 108 may validate the synthetic request by comparing the request data with expected results. The synthetic request may have been transformed by the multi-lender sub-system 104 and may be represented by a transformed synthetic request data object 114. The comparison may be done by comparing the transformed results of the synthetic request with expected results based on a pairwise comparison of the results with the expected results. Specifically, more than one attribute of the synthetic request may have been transformed by the multi-lender sub-system 104 and each of the attributes transformed by the multi-lender sub-system 104 may be compared with the corresponding expected result. In aspects, the mock servers 108 may generate a success message that the data transformations were accurately performed based on determining that all the results and the expected results match.

In aspects, the mock servers 108 may generate a synthetic response mimicking how lenders 110 would process the synthetic data input into the multi-lender sub-system 104, and transmit it back to the multi-lender sub-system 104. As shown in FIG. 1, the synthetic response may be represented by a synthetic response data object 116. For a synthetic response received from the multi-lender sub-system 104, the scanner module 102 may validate the synthetic response by comparing the response data with expected results. The synthetic response received by the scanner module 102 may have been transformed by the multi-lender sub-system 104 and may be represented by a transformed synthetic response data object 118. The comparison may be done by comparing the transformed results of the synthetic response with expected results based on a pairwise comparison of the transformed results with the expected results. Specifically, more than one attribute of the synthetic response may have been transformed by the multi-lender sub-system 104 and each of the attributes transformed by the multi-lender sub-system 104 may be compared with the corresponding expected result. The scanner module 102 may generate a success message that the data transformations were accurately performed based on determining that all the transformed results and the expected results match.

In order to test whether the multi-lender sub-system 104 is processing the inputs and outputs correctly, the synthetic request data object 112, when identified as such, is routed to specific components that are designed to mock/imitate lender behavior based on data transformations done by the multi-lender sub-system 104 on the synthetic request data object 112. These components are shown as the mock servers 108 in FIG. 1. Adding the mock servers 108 as a proxy to the synthetic request data object 112 allows the system 100 to test transformations and operations done on the synthetic request data object 112 by the sub-components of the multi-lender sub-system 104 and test these transformations against known outcomes to identify single points of failure in the multi-lender sub-system 104 that are performing those transformations.

In aspects, when a request is identified as synthetic, a synthetic pre-qualification application may be created for the request. The multi-lender sub-system 104 may transmit the synthetic request to the mock servers 108 instead of components of the multi-lender sub-system 104 used to process live/production data.

In aspects, and as previously indicated the transformations done on the synthetic request data object 112 by the multi-lender sub-system 104 may transform or translate attributes of the synthetic request data object 112 according to each lender's methodology and/or configurations. For example, an attribute may be received in a request by the multi-lender sub-system 104 in a first form and a lender may expect the attribute in a second form (e.g., the request provides a yearly income vs. a monthly income that is expected). The multi-lender sub-system 104 may transform the attribute from the first form into the second form before transmitting the pre-qualification request to the lender. The multi-lender sub-system 104 may perform transformations to more than one attribute in a request. The multi-lender sub-system 104 may perform similar transformations to attributes in a response.

For example, an attribute for an income of a user or an applicant included in a pre-qualification request may be transformed by the multi-lender sub-system 104. If the scanner module 102 is configured to send an annual income of $120,000 and a lender expects a monthly income instead, the multi-lender sub-system 104 may transform the annual income into a monthly income of a certain amount. The mock servers 108 may send a success message when the income transformed by the multi-lender sub-system 104 matches $10,000. Because the attributes of a synthetic request, including the income, were configured by the multi-lender sub-system 104, expected results of the transformation may be determined.

As another example, an attribute for a product included in a response may be transformed by the multi-lender sub-system 104. If the response data sent by the mock servers 108 contains “insurance product” as $500 and the scanner module 102 expects another type of product instead, the multi-lender sub-system 104 may transform the product name to another type of product. The scanner module 102 may validate that the other type of product being sent as $500 and send a success message when the product transformed by the multi-lender sub-system 104 matches the another type of product. Similarly, because the attributes of a synthetic response, including the product, were configured by the multi-lender sub-system 104, further expected results of the transformation may be determined.

Alternatively or additionally, further expected results included in a transformed response which is also included in the request may be used to validate accuracy of further data transformations performed by the multi-lender sub-system 104. Specifically, a response corresponding and/or responding to a request may include the expected results included in the request. When a response is transformed by the multi-lender sub-system 104, the further expected results in the response, also included in the request, may be used to validate accuracy of further data transformations performed by the multi-lender sub-system 104 on the expected results.

Specifically, a response to the above-mentioned pre-qualification request may include the monthly income of the user because the response generated by the mock servers 108 may mimic lender behavior. Because the scanner module 102 is configured to send an annual income in a request, it would expect an annual income in the response. The multi-lender sub-system 104 may transform the monthly income in the response into an annual income to meet the expectation of the scanner module 102 or eventually of an actual marketplace. After the transformation, the further expected results included in the transformed response may include an annual income of the client. The transformed income, now in annual form, may be used by the scanner module 102 to validate if the data transformation performed by multi-lender sub-system 104 on the response was correct.

In aspects, and as previously indicated in order to identify whether data is synthetic, the multi-lender sub-system 104 utilizes identifiers. In aspects, the multi-lender sub-system 104 may utilize identifiers (IDs) for various reasons, e.g. pre-qualification application IDs, offer IDs, pricing request IDs, and vehicle offer IDs. These IDs may be represented as universally unique identifiers (UUIDs). A reserved bit of a field of the UUID may be used to indicate if an applicant or client is synthetic and thus the corresponding request and/or response is synthetic. For example, the most significant bit of the variant field of the UUID may be used for this purpose. In aspects, a bit value of 1 may indicate a non-synthetic ID while a bit value of 0 may indicate a synthetic ID.

Additionally or alternatively, a synthetic pre-qualification/pricing application may be created by setting specific values within certain attributes of the synthetic request data object 112, such as first and last names, email addresses, and phone numbers of the synthetic user represented by the synthetic request data object 112. In other words, attributes of a synthetic request are configured to indicate the request is synthetic. The corresponding responses generated in response to processing the synthetic request data object 112 may also be synthetic.

In aspects, in order to determine whether data is synthetic or not, patterns within the data may be encoded and recognized by the multi-lender sub-system 104. For example, the first and last name indicated in the synthetic request data object 112 may not include specific types of letters such as any vowels or the letter “y”; the email address indicated in the synthetic request data object 112 may end with a specific character and/or a specific domain name; the telephone number indicated in the synthetic request data object 112 may be a specific number or have a fictitious area code that can readily be identified as synthetic.

In aspects, based on the specific patterns within the synthetic request data object 112, the mock servers 108 to which the data object is routed to, may know what specific data transformations should have been performed on the synthetic request data object 112 and what the processing of the synthetic request data object 112 should look like. In aspects, the status of an offer, e.g., how the offer for the pre-qualification application is determined, may be determined based on the value/pattern of one of the above attributes. In other words, the mock servers 108 may determine how the synthetic request data object 112 is to be tested based on the value/patterns of attributes of the synthetic request data object 112, e.g., for the transformations and/or the processing of the synthetic request data object 112. For example, the primary applicant's first name may be modified, e.g., by adding specific letters to the first name, to indicate different statuses of the offer. Thus the pre-qualification application offer status may be determined by a character sequence in the applicant's first name. For example, a simple approval or decline can be specified by including, or not, a single letter per lender in the applicant's first name. In aspects, a capital letter may be assigned to represent each one of a plurality of lenders and the capital letter may be inserted to the middle of the primary applicant's first name when a prequalification request is to be approved. Conversely, the absence of the corresponding capital letter in the primary applicant's first name may indicate that the prequalification request should be declined.

More letters may be used for more complex cases. In aspects, a two character sequence may be used in the primary applicant's first name to indicate more complex statuses such as approved with additional stipulations or verifications that need to be done and what those stipulations and verifications are. Also, a specific character in the first letter of the first name may represent that a particular lender is to process the data object and the second letter may represent the more complex status. Specifically, a more complex status of a pre-qualification offer corresponding to the pre-qualification request may be denoted by modifying letter pairs in the first name. For example, inserting into the middle of the first name of the primary applicant the format: [lender] [status]. In aspects, [lender] may comprise a capital letter representing a corresponding lender while [status] may comprise a more complex status of the pre-qualification offer from the corresponding lender such as cancelled ([c]), referred ([f]), pending further review ([p]), returned ([r]), approved with stipulations ([s]), verifying ([v]), expired ([x]), etc.

In aspects, the mock servers 108 may be configured with pre-generated scripts and/or rules that can facilitate testing with these various scenarios with known outcomes and/outputs that should be generated and/or can be tested based on these patterns within the synthetic request data object 112. Thus, as the synthetic request data object 112 is processed throughout the multi-lender sub-system 104, the scenarios can be matched with expected results based on the patterns within the data, and compared to known or generated outcomes to determine whether they match or not in order to verify whether the components of the multi-lender sub-system 104 are working properly.

The system 100 described above provides several benefits. First, the system 100 implements a novel architecture, which uses custom encoded data that can be used to test components and sub-components of integrated systems in a live/production environment. Through the use of this encoded data, test data can be identified by components of the live/production environment and routed to desired destinations throughout the production environment, without disturbing the functionality of the production environment and interfering with the processing of data that is not test data. Thus, the use of the architecture in conjunction with custom encoded data provides a novel way to test live systems for errors as they are working to identify errors and failure of components proactively.

By performing the testing in a live/production environment, errors can be quickly identified on actual systems that are processing real data. Conventional paradigms in testing differ, in that systems are typically tested in a test environment, deployed, and not tested again until failures occur. The disclosed system is different in that the testing is ongoing and using live components. This provides the benefit of alerting administrators of the system 100 in a real-time way of detecting errors and the source of those errors much faster than conventional systems.

By performing testing in this manner, system downtime is reduced and errors can be detected much faster than is the case using conventional testing paradigms. This improves the overall functioning of integrated system by providing higher levels of up-time.

The use of custom encoded data allows for testing to be done in a highly customized way and on a component by component basis without having to isolate those components to do the testing. The patterns in the custom encoded data can dictate what components are to be tested and what the results of those tests can/should be. In this way, tests data can be routed to the correct components and compared against baselines to quickly validate whether it is being correctly processed or not.

Moreover, not only can the use of synthetic data, which is formatted, patterned, and structured in a unique way, for testing simplify and ensure the identification and routing of the test data, but also patterns of attributes of the test data can indicate how the test data should be tested after being routed to a desired destination. Custom tests thus can be performed on the test data based on detecting the patterns within the data. The patterns of the attributes can be varied by modifying values associated with the test data.

### Methods of Operation

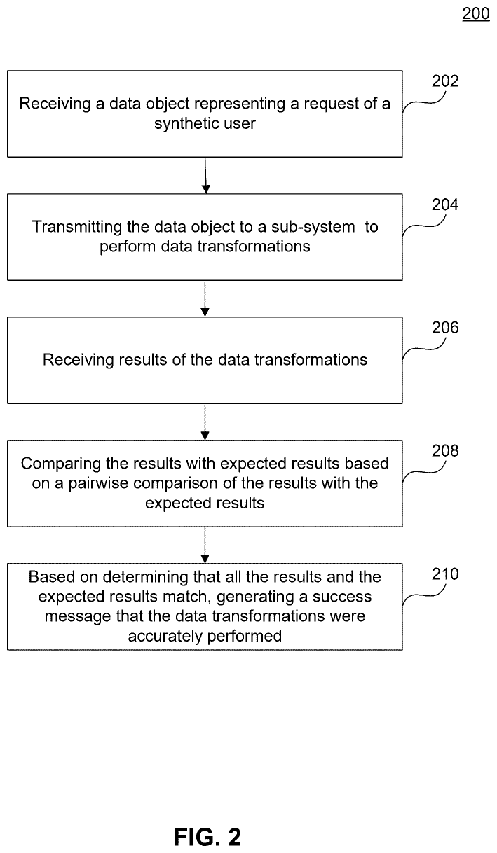

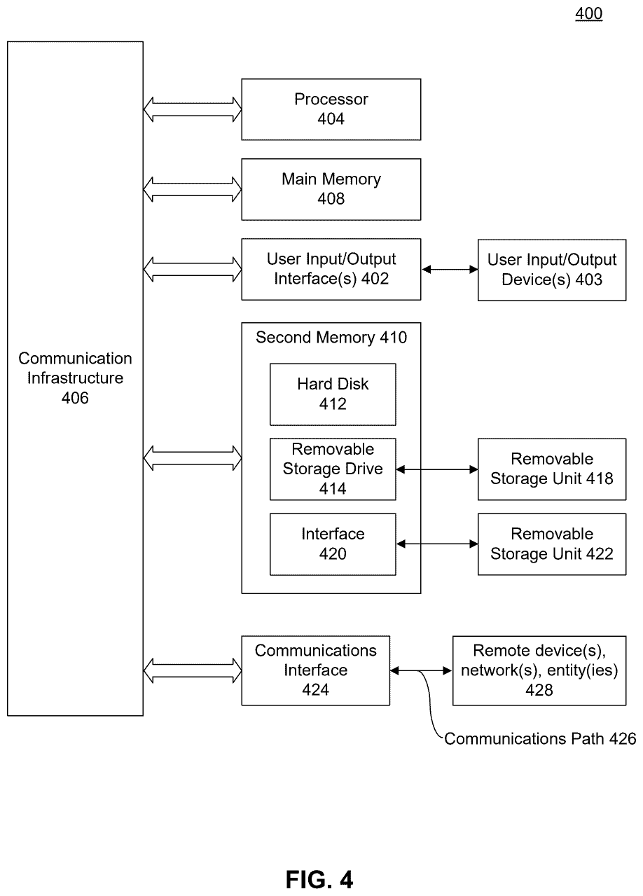

FIG. 2 is an example method 200 of operating the system 100 according to aspects. Method 200 may be implemented on computing devices, for example the computing device shown in FIG. 4.

In aspects, method 200 may begin by receiving a data object (e.g., the synthetic request data object 112) representing a request of a synthetic user, as shown in step 202. In aspects, the synthetic request data object 112 may be received by the data accuracy control scanner (scanner) module 102. In aspects, the synthetic request data object 112 may comprise encoded attributes of the synthetic user and the encoded attributes may be used to validate accuracy of data transformations performed by a sub-system (e.g., the multi-lender sub-system 104) on the encoded attributes. In aspects, validating the accuracy of the data transformations may be done in real-time and during a production session of the multi-lender sub-system 104.

The scanner module 102 may transmit the synthetic request data object 112 to the multi-lender sub-system 104 to perform the data transformations, as shown in step 204. The mock servers 108 may receive results (e.g., included in the transformed synthetic request data object 114) of the data transformations, as shown in step 206. The mock servers 108 may compare the results included in the transformed synthetic request data object 114 with expected results based on a pairwise comparison of the transformed synthetic request data object 114 with the expected results, as shown in step 208. Based on determining that all the results and the expected results match, the mock servers 108 may generate a success message that the data transformations were accurately performed, as shown in step 210. Conversely, based on determining that not all the results and the expected results match, the mock servers 108 may generate an error message that the data transformations were incorrectly performed.

The operation of method 200 is performed, for example, by system 100, in accordance with aspects described above. The functions described may be performed according to and consistent with FIGS. 1 and 2, and by the scanner module 102, the multi-lender sub-system 104, and the mock servers 108 or their equivalents as described above. Such modules may be combined in various ways or manners to perform the functions described with respect to method 200.

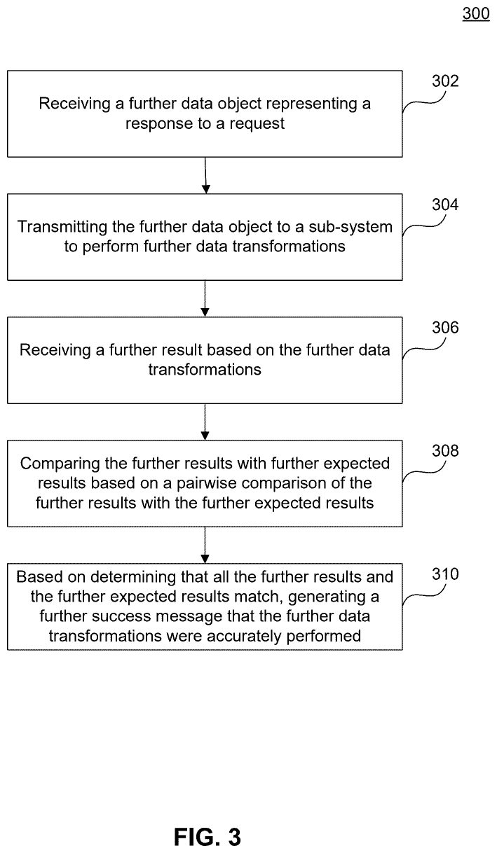

FIG. 3 is an example method 300 of operating the system 100 according to aspects. Method 300 may be implemented on computing devices, for example the computing devices of the computer system 400.

In aspects, method 300 may begin by receiving a further data object (e.g., the synthetic response data object 116) representing a response to a request, as shown in step 302. In aspects, the synthetic response data object 116 may be generated or received by the mock servers 108. In aspects, the synthetic response data object 116 may comprise expected results, e.g., included in the transformed request (e.g., the transformed synthetic request data object 114), which may be used to validate accuracy of further data transformations performed by a sub-system (e.g., the multi-lender sub-system 104) on the expected results. In aspects, validating the accuracy of the further data transformations may be done in real-time and during the production session of the multi-lender sub-system 104.

The mock servers 108 may transmit the synthetic response data object 116 to the multi-lender sub-system 104 to perform the further data transformations, as shown in step 304. The scanner module 102 may receive a further result (e.g., the transformed synthetic response data object 118) based on the further data transformations, as shown in step 306. The scanner module 102 may compare the transformed synthetic response data object 118 with further expected results based on a pairwise comparison of the transformed synthetic response data object 118 with the further expected results, as shown in step 308. Based on determining that all the further results of the transformed synthetic response data object 118 and the further expected results match, the scanner 102 may generate a further success message that the further data transformations were accurately performed, as shown in step 310. Conversely, based on determining that not all the further results of the transformed synthetic response data object 118 and the further expected results match, the scanner 102 may generate an error message that the further data transformations were incorrectly performed.

The operation of method 300 is performed, for example, by system 100, in accordance with aspects described above. The functions described may be performed according to and consistent with FIGS. 1 and 2, and by the scanner module 102, the multi-lender sub-system 104, and the mock servers 108 or their equivalents as described above. Such modules may be combined in various ways or manners to perform the functions described with respect to method 300.

### Components of the System

Various aspects can be implemented, for example, using one or more well-known computer systems, such as computer system 400 shown in FIG. 4. Computer system 400 can be any well-known computer capable of performing the functions described herein, such as computers available from International Business Machines, Apple, Sun, HP, Dell, Sony, Toshiba, etc.

Computer system 400 includes one or more processors (also called central processing units, or CPUs), such as a processor 404. Processor 404 is connected to a communication infrastructure or bus 406. Processor 404 may be a graphics processing unit (GPU). In some aspects, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., which communicate with communication infrastructure or bus 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Aspects of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

Based on the teachings contained in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

The foregoing description of the specific aspects will so fully reveal the general nature of the aspects that others may, by applying knowledge within the skill of the art, readily modify and/or adapt for various applications such specific aspects, without undue experimentation, without departing from the general concept of the present aspects. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present aspects should not be limited by any of the above-described exemplary aspects, but should be defined in accordance with the following claims and their equivalents.

1. A computer-implemented method, the method comprising:
determining, by one or more computing devices, whether a data object represents a synthetic user based on a value of a most significant bit in a predetermined field of a universally unique identifier (UUID) associated with the data object;
based on determining that the data object represents the synthetic user, routing, by the one or more computing devices, the data object through a production session of a sub-system to a desired destination;
detecting, by the one or more computing devices and at the desired destination, patterns of attributes of the data object indicative of how the data object is to be tested at the desired destination; and
based on detecting the patterns within the data object, performing, by the one or more computing devices, custom tests on the data object, wherein the custom tests performed are based the patterns of attributes.

2. The method of claim 1, further comprising, determining, by the one or more computing devices, whether the data object is synthetic based on the most significant bit in the predetermined field of the UUID having a bit value of 0.

3. The method of claim 1, wherein the patterns of attributes comprise:
a first and last names associated with the data object not including any vowels or a letter “y”;
an email address associated with the data object ending with a predetermined term or a predetermined domain name; and
a telephone number associated with the data object having a predetermined number.

4. The method of claim 1, wherein the data object represents an application for a pre-qualification or a pricing term for a good.

5. The method of claim 4, wherein the patterns of attributes indicate whether the data object should be approved or rejected for the pre-qualification or the pricing term.

6. The method of claim 3, wherein the patterns of attributes are varied by modifying letters in the first name associated with the data object.

7. The method of claim 3, wherein the patterns of attributes are varied by modifying letter pairs in the first name associated with the data object.

8. A non-transitory computer readable medium storing instructions, that when executed by one or more processors of a computing system, cause the computing system to perform operations comprising:
determining whether a data object represents a synthetic user based on a value of a most significant bit in a predetermined field of a universally unique identifier (UUID) associated with the data object;
based on determining that the data object represents the synthetic user, routing the data object through a production session of a sub-system to a desired destination;
detecting at the desired destination, patterns of attributes of the data object indicative of how the data object is to be tested at the desired destination; and
based on detecting the patterns within the data object, performing custom tests on the data object, wherein the custom tests performed are based the patterns of attributes.

9. The non-transitory computer readable medium of claim 8, wherein the operations further comprise, determining whether the data object is synthetic based on the most significant bit in the predetermined field of the UUID having a bit value of 0.

10. The non-transitory computer readable medium of claim 8, wherein the patterns of attributes comprise:
a first and last names associated with the data object not including any vowels or a letter “y”;
an email address associated with the data object ending with a predetermined term or a predetermined domain name; and
a telephone number associated with the data object having a predetermined number.

11. The non-transitory computer readable medium of claim 8, wherein the data object represents an application for a pre-qualification or a pricing term for a good.

12. The non-transitory computer readable medium of claim 11, wherein the patterns of attributes indicate whether the data object should be approved or rejected for the pre-qualification or the pricing term.

13. The non-transitory computer readable medium of claim 10, wherein the patterns of attributes are varied by modifying letters in the first name associated with the data object.

14. The non-transitory computer readable medium of claim 10, wherein the patterns of attributes are varied by modifying letter pairs in the first name associated with the data object.

15. A computing system comprising:
a memory storing instructions; and
one or more processors, configured to process the stored instructions to:
determine whether a data object represents a synthetic user based on a value of a most significant bit in a predetermined field of a universally unique identifier (UUID) associated with the data object;
based on determining that the data object represents the synthetic user, route the data object through a production session of a sub-system to a desired destination;
detect at the desired destination, patterns of attributes of the data object indicative of how the data object is to be tested at the desired destination; and
based on detecting the patterns within the data object, perform custom tests on the data object, wherein the custom tests performed are based the patterns of attributes.

16. The system of claim 15, wherein the one or more processors are further configured to, determine whether the data object is synthetic based on the most significant bit in the predetermined field of the UUID having a bit value of 0.

17. The system of claim 15, wherein the patterns of attributes comprise:
a first and last names associated with the data object not including any vowels or a letter “y”;
an email address associated with the data object ending with a predetermined term or a predetermined domain name; and
a telephone number associated with the data object having a predetermined number.

18. The system of claim 15, wherein the data object represents an application for a pre-qualification or a pricing term for a good.

19. The system of claim 17, wherein the patterns of attributes are varied by modifying letters in the first name associated with the data object.

20. The system of claim 17, wherein the patterns of attributes are varied by modifying letter pairs in the first name associated with the data object.
